(19) United States
(12) Patent Application Publication
(10) Pub. No.: US 2012/0285310 A1
(43) Pub. Date: Nov. 15, 2012

(54) Acoustic String Guitar

(76) Inventor: Michael Miltimore, Kamloops (CA)

(21) Appl. No.: 13/107,940

(22) Filed: May 15, 2011

(51) Int. Cl. G10D 3/00; B23P 11/00

(52) U.S. Cl. 84/291; 29/896.22

(57) ABSTRACT

A musical instrument of the chordophone family is provided that has reduced stresses and strains, and is easily assembled. A braceless system both reduces the stresses and allows for the elimination of bracing. As a consequence, a binding and kerfing unit is used, further increasing the ease of construction. Additionally, the instrument is provided with an offset headstock to allow the strings to be normal to the bridge, still further reducing the stresses and strains in the instrument. A method of constructing the instrument is also provided.

### FIELD

The present technology is directed to a string instrument in which the stresses and strains on the soundboard are reduced through the implementation of a braceless system and an offset headstock. More specifically, the present technology is directed to a guitar having the braceless system and an offset headstock.

### BACKGROUND

Acoustic string instruments are subjected to high stresses and strains caused by the strings. As the instrument is tuned, the strings are tightened, leading to force developing between the neck and the soundbox. The direct recipient of the force is the bridge. The force is then indirectly exerted on the soundboard. This may lead to damage to both the bridge and the soundboard. In extreme cases, the neck can also be affected by damaging the joint between the neck and the soundbox of the instrument.

The inner surfaces of the soundboard and back of guitars are provided with bracing to counteract the force. A complex pattern of bracing is used on the inner surface of the back. During construction of the instrument, a luthier spends a significant amount of time shaping the bracing in order to tune the instrument. In order to reduce the work, Griffiths (U.S. Pat. No. 6,333,454) provides a bracing system that combines kerfing, binding and bracing. One unit is for use with the soundboard and a second unit is for use with the back.

In U.S. Pat. No. 7,462,767, a bracing system is used to counter balance the force by using an additional string or cable, preferably made of Kevlar, carbon fiber or a similar non-elastic material, that is attached to the bridge and the neck of the guitar within the soundbox. A bracket is located inside the soundbox of the instrument and attached to the bottom of the bridge of the instrument. It is connected to an adjustable brace by a non-elastic string. The adjustable brace may adjust the tension placed upon the string to control the amount of counter-balancing tension. This system does not alleviate the force, but rather, simply counter balances the force.

Another cause of stress to the instrument arises because the strings are not aligned between the headstock and the bridge such that they are normal to the bridge. The strings therefore exert a twisting force on the bridge and soundbox.

Despite the fact that many instruments are damaged by the two forces, those of the force on the bridge and soundboard and the force on the neck and the soundbox, the string instrument industry is reluctant to make change to reduce the forces exerted, preferring to retain the “look” of the instrument in preference to the health of the instrument.

### SUMMARY

The present technology provides a system for reducing the forces exerted on instruments in the chordophone family by the strings. The braceless system reduces the tension on the soundboard and the span thereby allowing the top to resonate freely without bracing for strength, as much of the tension is relieved. A further reduction in stresses and strains on the instrument can be provided by an offset headstock. This allows for the strings to remain normal to the span, as the offset side has two tuning keys and the side opposite to the offset has four tuning keys.

An additional advantage of the braceless system is the saving in construction time. As the name suggests, there is no need for bracing. Consequently, there is no need for the luthier to spend hours tuning the soundboard by carefully carving away bracing in order to achieve the desired tone.

The technology further provides a universal binding and kerfing unit. The unit is universal in that it can be used interchangeably for connecting the soundboard to the sides and the back to the sides. This allows for easy and quick assembly of the string instrument.

### FIGURES

FIG. 1 is a perspective view of the guitar of the present technology.

FIG. 2 is a longitudinal section view of the guitar of FIG. 1.

FIG. 3 is a view of the binding and kerfing unit of the present technology.

FIG. 4 is a plan view of the floating bridge region of the braceless system of the present technology.

FIG. 5 is a perspective view with cutaway of the guitar of the present technology.

FIG. 6 is an exploded view of the neck region of the braceless system.

FIG. 7 is a longitudinal section view of the floating bridge.

### DETAILED DESCRIPTION

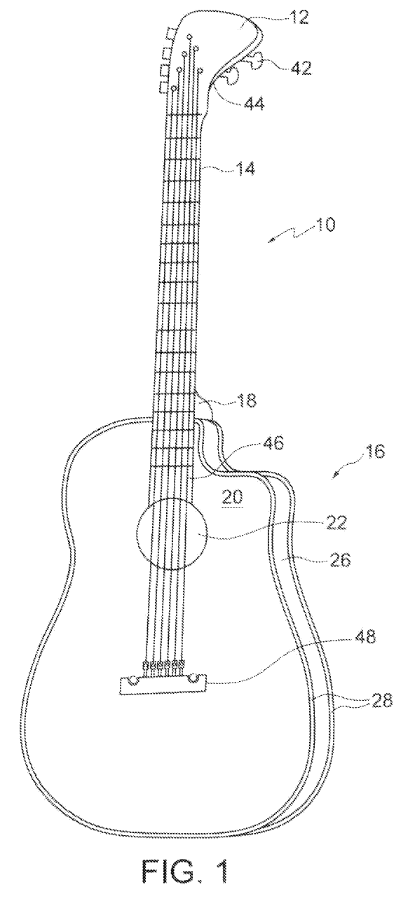

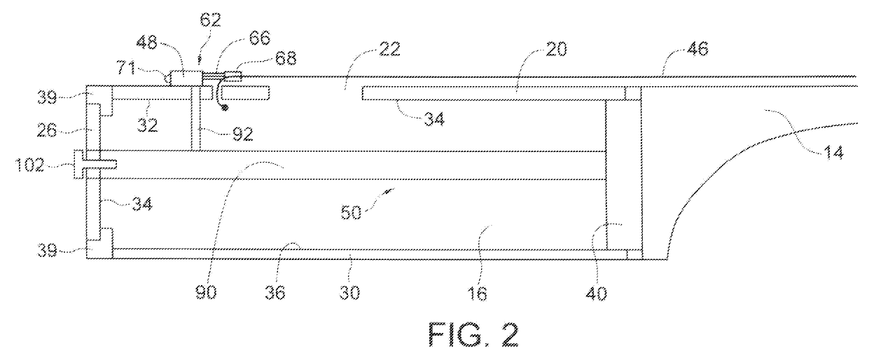

A guitar, generally referred to as 10 is shown in FIG. 1. The guitar has a headstock 12 and a neck 14 extending therefrom. The neck 14 is connected to a soundbox, generally referred to as 16 at a proximal end 18 of the neck 14. The soundbox 16 has a soundboard 20 forming the top of the soundbox 16. A sound hole 22 is located centrally in the soundboard 20. Binding 28 can be seen between the soundboard 20 and the sides 26. As can be seen in FIG. 2, binding 28 can is also between the back 30 of the guitar 10 and the sides 26. The binding 28 is provided as a binding and kerfing unit 39.

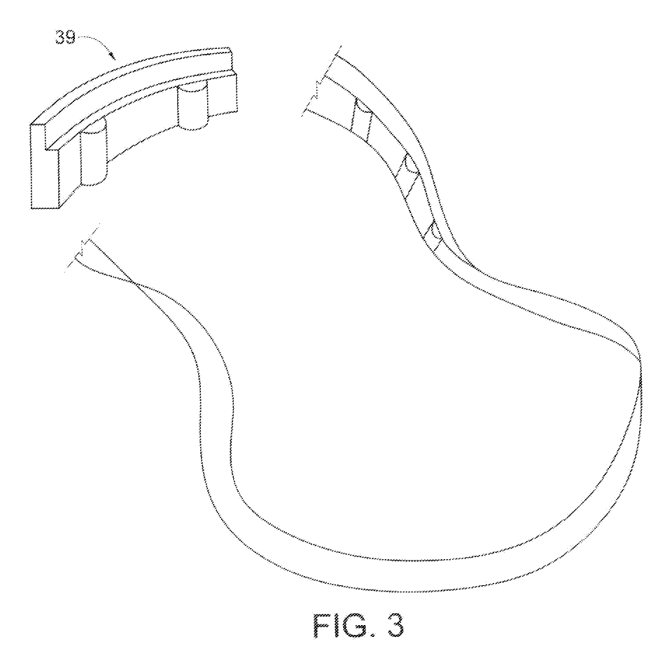

Referring still to FIG. 2, it can be seen that the soundbox 16 is defined by the inner surface 32 of the soundboard 20, the inner surface 32 of the sides 26 and the inner surface 36 of the back 30. The binding and kerfing unit 39, runs the perimeter of the joints between the sides 26 and both the soundboard 20 and the back 30 on the side inner surfaces 32, 36 and distal inner surface 34, and provides structural support for the soundbox 16. As can be seen in FIG. 3, the binding and kerfing unit 39 is universal in that it can be used interchangeably for connecting the soundboard 20 to the sides 26 and the back 30 to the sides 26. Returning to FIG. 2, a neckblock 40 is located in the soundbox 16 proximate the neck 14.

Returning to FIG. 1, the headstock 12 is provided with tuning keys 42. In the prior art, the headstock is symmetrical and there are an equal number of tuning keys 42 on either side of the headstock 12. In contrast the headstock 12 of the present technology has an offset 44. There are two tuning keys 42 located on the same side as the offset 44 and four tuning keys 42 located on the side opposite to the offset 44. This allows the strings 46 to extend in a parallel manner between the headstock 12 and the span 48 and to be normal to the span 48.

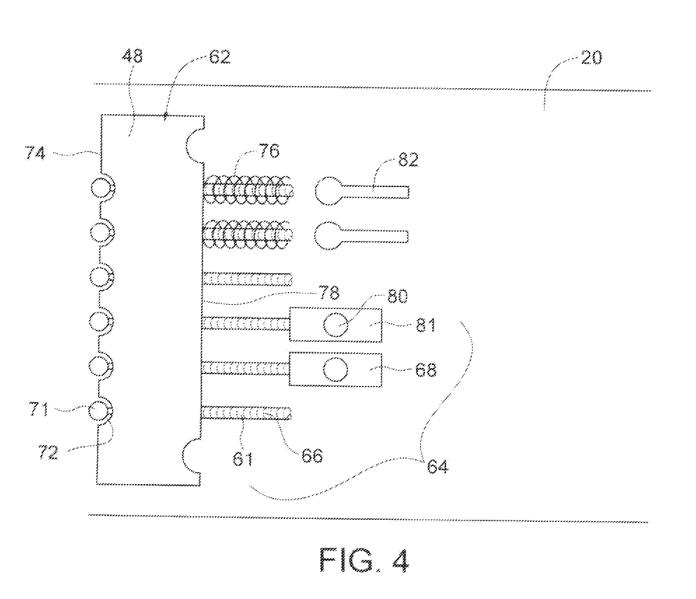

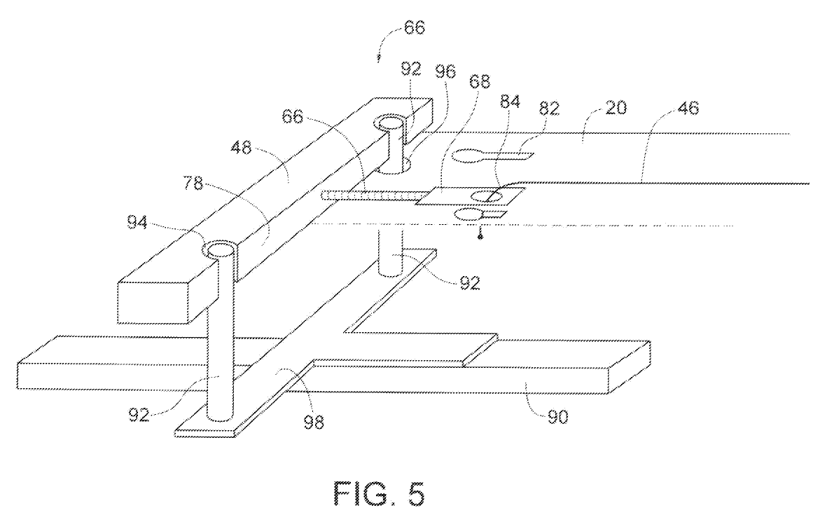

As shown in FIG. 2, the strings 46 do not terminate at pins that are engaged with the bridge as occurs in the guitar prior art or the tail piece as occurs in the violin prior art, but rather continue to a floating bridge, generally referred to as 62. The floating bridge 62 is part of a braceless system, generally referred to as 50. As shown in FIG. 4, the floating bridge 62 consists of a span 48, and a member 64 that includes a series of fingers 66, a series of bodies 68 and a series of connectors 70. As shown in FIG. 5, the bodies 68 are in engagement with the span 48 by means of the fingers 66 and the connector 70 to create a pivot point 84. The pivot point 84 should be aligned in the same plane as the strings 46. The combination of the fingers and connectors both allows for adjusting intonation of each string 46 and relieves tensions that would normally be present on the bridge and top of a conventional guitar. This allows the soundboard 20 to function solely as a resonant membrane rather than a structural support and resonant membrane.

In one embodiment a threaded ball 71 functions as the connector 70. Each finger 66 terminates in a ball 71 that is located in a socket 72 on a distal side 74 of the span 48. This allows for rotational movement of the fingers 66. The fingers 66 are threaded 61 and are therefore in adjustable engagement with the bodies 68. A spring 76 surrounds each finger 66 and extends between the proximal side 78 of the span 48 and each body 68. As shown in FIG. 2, each body 68 has a wedge-shaped opening 80 at a proximal end 81 to engage the strings 46. The strings pass through the wedge-shapes openings 80 and terminate in individual keyholes 82 in the soundboard 20 of the guitar 10.

In another embodiment, the connector is integral with the finger 66 and the unit is constructed of a material, such as a plastic polymer, that permits flexing between these components. In all embodiments, in order to reduce stresses on the soundboard 20, it is preferable that the circular movement of the strings 46 when strummed is accommodated by resultant movement of the bodies 68 in at least two planes (up and down and side to side) and preferably in a circle, therefore in all embodiments the connector, whether integral or not is selected to provide such movement (referred to as “substantially rotatable”). This differs from a conventional guitar as the pins of a conventional guitar only accommodate up and down movement of the strings 46, again resulting in torsional stress on the soundboard.

As shown in FIG. 5, the floating bridge 62 is attached to a strut 90 by means of two adjustable posts 92, for example, bolts. More specifically, the posts 92 slot into keyways 94 in the proximal side 78 of the span 48, pass through floating bridge apertures 96 in the soundboard 20, and are threadably attached to a T 98, which in turn is attached to the strut 90.

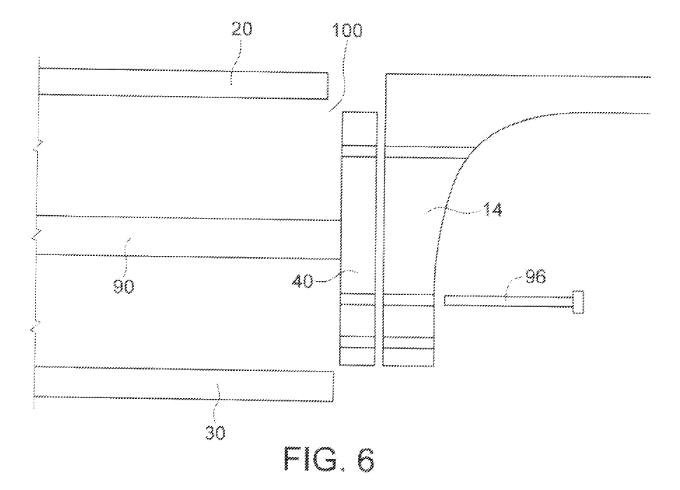

As shown in FIG. 6, it can be seen that a soundbox aperture 100 is provided in the soundbox 16 for receiving the neck 14, neckblock 40 and strut 90, with the T 98 attached. These can be assembled and then introduced as a unit. Returning to FIG. 2, the strut 90 abuts the distal inner surface 34, and is adjustably affixed to the distal inner surface 34 by a bolt 102 or by the strap peg. Further adjustment can be made by tightening or loosening the posts 92. These adjustments alter the effective length of the strut. Effective length in this context is measured as the distance between the inner surface 36 of the back 30 and the neckblock 40.

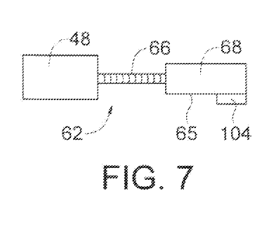

As shown in FIG. 7, the bodies 68 are preferably each provided with transducers 104 or musical instrument digital interface (MIDI), located in the vicinity of the bottom 65 of the bodies 64. This allows for individual processing of each string.

The guitar of the present technology can be assembled very quickly as follows:

### 1. Construction of the Body of the Guitar:

The binding and kerfing unit 39 is used to attach the sides 26 to the soundboard 20 and back 30 of the guitar 10.

### 2. Introduction of the Braceless System:

The neck 14, neckblock 40 and strut 90, with the T 98 attached are slid into the soundbox 16 of the guitar 10 as a unit, through the soundbox aperture 100. The strut 90 abuts the distal inner surface 34, and is adjustably affixed to the distal inner surface 34 by a bolt 102 or by the strap peg. The braceless system 50 is then assembled by placing the floating bridge 62 comprising the span 48, the series of fingers 66 and the series of bodies 68 on the soundboard 20, slotting posts 92 into the keyways 94 in the proximal side 78 of the span 48, passing the posts 92 through apertures 96 in the soundboard 20 and attaching them to the T 98. Further adjustment can be made by tightening or loosening the posts 92, allowing for intonating the guitar 10. The pivot point 84 should be aligned in the same plane as the strings 46.

### 3. Adjustment of the Braceless System:

Adjustments are made by tightening or loosening the posts 92 and/or the bolt 102. This in turn adjusts the force exerted on the floating bridge 62.

### 4. Stringing the Instrument:

The instrument is strung by securing each string 46 in the wedge-shaped opening 80 and through the soundboard 20 via the keyholes 82. It is important that the string pull comes from the wedge-shaped opening 80. The strings 46 are wound onto the tuning keys 42, noting that the alignment of the strings 46 is kept normal to the span 48 by the offset 44.

The foregoing is a description of an embodiment of the technology. As would be known to one skilled in the art, variations that do not alter the scope of the technology are contemplated. For example, the instrument may have more or less than six strings and need not be a guitar, but any instrument in the chordophone family, for example but not limited to a violin, a ukulele, lute or mandolin. Regardless of the plurality of strings, the offset will allow for an uneven distribution of the tuning keys between the sides of the headstock, thereby allowing for the strings to be normal to the span. Further, more than one set of strings can be used, for example, the instrument could have a six string and twelve strings embodiment, wherein two braceless systems would be used having a total of four struts, or a combination wherein three struts were employed. A bolt 86 or other connector, such as a screw, could adjustably attach each finger 66 to the span 48, with a rubber bushing 88 separating the finger 66 from the span 48. The thickness and tensile strength of the components would be selected to permit flexing. The braceless system can be constructed in a number of ways. For example, the neck and strut could be a unit body construction, the strut could be a solid member, or could be a truss, and the floating bridge could be a variety of shapes, the constraints being that the torsional stress on the soundboard is reduced or eliminated by providing a connector that is substantially rotatably attached to the span and is substantially parallel to the strut, such that the force of the string pull is directed to the floating bridge and not to the soundboard of the instrument. The binding and kerfing unit may be constructed of a number of materials, including but not limited to a plastic polymer, aluminum, titanium, graphite, carbon fibre or brass.
comprises attaching two strings to the tuning keys in the vicinity of the offset and four strings to the tuning keys opposite the offset.

1. A braceless system for a chordophone instrument, the instrument having a neck and a soundbox, the braceless system comprising:
i) at least one rigid strut that is adjustable in situ;
ii) a floating bridge comprising:
a span; and
at least one member substantially rotatably connected to the span, the member configured to accept a string in the vicinity of the proximal end of the member; and
iii) at least one post for adjustably connecting the floating bridge to the strut.

2. The braceless system of claim 1 wherein the member is adjustable.

3. The braceless system of claim 2 wherein the member comprises a body, a finger and a connector.

4. The braceless system of claim 3 wherein there are six members.

5. The braceless system of claim 4 further comprising six transducers located on the bodies.

6. A chordophone instrument having a headstock, a neck, a bridge, at least one string and a soundbox, the soundbox comprising a soundboard, sides and a back, wherein the improvement comprises a floating bridge aperture in the soundboard and a braceless system, the braceless system comprising:
i) a strut housed in the soundbox and adjustably attached therein;
ii) at least post extending upwards towards the floating bridge aperture; and
iii) a floating bridge comprising:
a span; and
at least one member substantially rotatably connected to the span, the member configured to accept a string,
wherein the at least one string extends from the headstock through the at least one member terminating in an at least one hole of the soundboard.

7. The instrument of claim 6 wherein the member comprises a body for accepting the string such that a pivot point is defined.

8. The instrument of claim 6 wherein the member is adjustable.

9. The instrument of claim 8 wherein the member comprises a body, a finger and a connector.

10. The instrument of claim 9 wherein the connector is a ball end for locating in a socket on a distal side of the span.

11. The instrument of claim 10 wherein the finger is provided with a spring therearound.

12. The instrument of claim 10 wherein the instrument is a guitar.

13. The instrument of claim 12, further characterized in that the headstock has an offset.

14. The instrument of claim 13 wherein the headstock is configured such that two strings terminate in the vicinity of the offset and four strings terminate opposite the offset.

15. The instrument of claim 12, further characterized in that the soundbox has a universal kerfing and binding unit.

16. The instrument of claim 6 further comprising an at least one transducer located in the vicinity of a proximal end of the at least one member.

17. A headstock for a chordophone instrument having a bridge and strings, the headstock comprising an offset side and an opposite side and being configured to accept fewer tuning keys on the offset side, such that in use, the strings are normal to the bridge.

18. The headstock of claim 17, wherein the headstock is configured to accept two tuning keys on the offset side and four tuning keys on the opposite side.

19. A method of constructing a chordophone instrument, the method comprising:
attaching a back and a soundboard to sides to provide a soundbox having a soundbox aperture;
connecting the braceless system of claim 1 to the neckblock;
introducing the braceless system and neckblock into the soundbox through the soundbox aperture;
locating the floating bridge on the soundboard;
affixing the floating bridge to the strut with the posts;
affixing the strut in the soundbox; and
stringing the instrument.

20. The method of claim 19 further comprising adjusting the effective length of the strut.
